(19) United States
(12) Patent Application Publication
(10) Pub. No.: US 2024/0160186 A1
(43) Pub. Date: May 16, 2024

(54) APPARATUSES, COMPUTER-IMPLEMENTED METHODS, AND COMPUTER PROGRAM PRODUCTS FOR PLANTWIDE OPTIMIZATION WITH MULTISTAGE PRE-BLENDING

(71) Applicant: Honeywell International Inc., Charlotte, NC (US)

(72) Inventor: Joseph Z. LU, Glendale, AZ (US)

(21) Appl. No.: 18/184,954

(22) Filed: Mar. 16, 2023

Related U.S. Application Data
(60) Provisional application No. 63/384,025, filed on Nov. 16, 2022.

(51) Int. Cl. G05B 19/418

(52) U.S. Cl. CPC G05B 19/41835; G05B 2219/32291

(57) ABSTRACT

Embodiments of the present disclosure provide for improved plantwide optimization with multistage pre-blending. Some embodiments generate a virtual representation of a plant that aggregates multiple stage components of the plant, process at least the virtual representation via a single-stage optimization process, cause production based on the results of the single-stage optimization process, generate an indicator of whether quality data for a preblended product, and cause routing, further processing, and/or the like, based on the specification satisfaction indicator. In this regard, some such embodiments optimize operation of a processing plant in circumstances where multistage blending is performed, such as due to expected and/or unexpected errors in operation for producing a particular final product.

### CROSS REFERENCE TO RELATED APPLICATIONS

This application claims the benefit of U.S. Provisional Patent App. No. 63/384,025, filed Nov. 16, 2022, the contents of which are incorporated by reference herein in their entireties.

### BACKGROUND

Some plant implementations, such as oil refineries, utilize multi-stage blending via one or more processing unit(s), machine(s), and/or other system component(s) of the plant, and operate in a particular manner utilizing such process unit(s), machine(s), and/or other system component(s) to produce a particular product. Often, when a product is produced, error(s), tank heel(s), and/or other external forces may cause the product to deviate outside of expected and/or acceptable range(s) of specifications for a desired product.

Applicant has discovered problems with current implementations of optimizing operation of a processing plant that performs multi-stage blending. Through applied effort, ingenuity, and innovation, Applicant has solved many of these identified problems by developing embodied in the present disclosure, which are described in detail below.

### BRIEF SUMMARY

In one aspect, a computer-implemented method includes generating a virtual representation of a processing plant, where the virtual representation includes an aggregation of a plurality of stage components of the processing plant into a single virtual stage component, generating at least one optimized operational parameter utilizing at least one single-stage optimization process based at least in part on the virtual representation of the processing plant, causing production, via at least a first stage component of the plurality of components of the processing plant, of a preblended product with minimized deviation from the at least one optimized operational parameter, generating specification satisfaction indicator by determining whether quality data corresponding to the preblended product satisfies specification requirements data, and causing routing of the preblended product based at least in part on the specification satisfaction indicator.

The computer-implemented method may also include where causing routing the preblended product based at least in part on the specification satisfaction indicator includes determining that the specification satisfaction indicator includes a first value representing that the quality data corresponding to the preblended product does not satisfy the specification requirements data, and causing routing of the preblended product to a subsequent stage component of the plurality of stage components of the processing plant.

The computer-implemented method may also include where causing routing the preblended product based at least in part on the specification satisfaction indicator includes determining that the specification satisfaction indicator includes a second value represent that the quality data corresponding to the preblended product satisfies the specification requirements data, and causing routing of the preblended product that skips at least one subsequent stage component of the plurality of stage components of the processing plant.

The computer-implemented method may also include where at least one optimized operational parameter includes a target ingredient amount inputted to the first stage component during production of the preblended product. Other technical features may be readily apparent to one skilled in the art from the following FIGURES, descriptions, and claims.

The computer-implemented method may also include the computer-implemented method further includes at least once causing production, via the subsequent stage component of the plurality of components of the processing plant, of a subsequent stage product with based at least in part on a minimal trim optimization process, generating subsequent specification satisfaction indicator by determining whether subsequent quality data corresponding to the subsequent stage product satisfies the specification requirements data, and causing routing of the subsequent stage product based at least in part on the subsequent specification satisfaction indicator.

The computer-implemented method may also include where causing routing of the preblended product based at least in part on the subsequent specification satisfaction indicator includes determining that the subsequent specification satisfaction indicator includes a second value representing that the subsequent quality data corresponding to the subsequent stage product does not satisfy the specification requirements data, and causing repeated production via the subsequent stage component.

The computer-implemented method may also include where causing routing of the preblended product based at least in part on the subsequent specification satisfaction indicator includes determining that the subsequent specification satisfaction indicator includes a second value representing that the second quality data corresponding to the subsequent stage product satisfies the specification requirements data, and causing routing of the subsequent stage product that skips any subsequent iteration of the at least one subsequent stage component of the plurality of stage components of the processing plant.

The computer-implemented method may also include where causing routing of the preblended product that skips at least one subsequent stage component includes causing outputting of the preblended product.

In accordance with another aspect of the present disclosure, an apparatus is provided. In one example embodiment of the apparatus, the apparatus includes at least one processor and at least one memory having computer-coded instructions stored thereon that, in execution with the at least one processor, causes the apparatus to perform any one of the example computer-implemented methods described herein. In another example embodiment of the apparatus, the apparatus includes means for performing each step of any one of the example computer-implemented methods described herein.

In accordance with another aspect of the present disclosure, a computer program product is provided. In one example embodiment of the computer program product, the computer program product includes at least one non-transitory computer-readable storage medium having computer program code stored thereon that, in execution with at least one processor, configures the computer program product for performing any one of the example computer-implemented methods described herein.

Other technical features may be readily apparent to one skilled in the art from the following FIGURES, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of a system that may be specially configured within which embodiments of the present disclosure may operate.

FIG. 2 illustrates a block diagram of an example apparatus that may be specially configured in accordance with an example embodiment of the present disclosure.

FIG. 3 illustrates a flowsheet model of a physical layout of an example processing plant configured for multi-stage operation in accordance with at least an example embodiment of the present disclosure.

FIG. 4 illustrates a flowsheet model of an example processing plant configured for multi-stage operation virtualized for optimization in accordance with at least an example embodiment of the present disclosure.

FIG. 5 illustrates an example implementation of a single-stage optimization process in accordance with at least an example embodiment of the present disclosure.

FIG. 6 illustrates an example implementation of a minimal trim optimization process in accordance with at least an example embodiment of the present disclosure.

FIG. 7 illustrates a process 700 for optimizing production in a multi-stage blending configured processing plant, in accordance with an example embodiment of the present disclosure.

FIG. 8 illustrates a process 800 for routing of a product to skip a subsequent stage, for example as part of an example process for optimizing production in a multi-stage blending configured processing plant, in accordance with an example embodiment of the present disclosure.

FIG. 9 illustrates a process 900 for routing a product to a subsequent stage component, for example as part of an example process for optimizing production in a multi-stage blending configured processing plant, in accordance with an example embodiment of the present disclosure.

FIG. 10 illustrates a process 1000 for producing and routing a subsequent stage product, for example as part of an example process for optimizing production in a multi-stage blending configured processing plant, in accordance with an example embodiment of the present disclosure.

FIG. 11 illustrates a process 1100 for iterative repeated production via a plurality of subsequent stage components, for example as part of an example process for optimizing production in a multi-stage blending configured processing plant, in accordance with an example embodiment of the present disclosure.

FIG. 12 illustrates a process 1200 for routing a subsequent stage product to skip a subsequent stage, for example as part of an example process for optimizing production in a multi-stage blending configured processing plant, in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Definitions

“Aggregation” with respect to a plurality of components refers to a mathematical combination of operation of the plurality of components. In some embodiments, aggregation represents encapsulation or other mathematical manipulation of operation of one or more subsequent stage component as subsumed by operation of a first stage component in a processing plant to generate a single-stage virtual representation of such component(s).

“Component” and “physical component” refer to a machine, tank, pipe, or other physical structure, or virtual representation of a structure, within a processing plant that is utilized in a process performed by the processing plant. In an example context of an oil refinery plant, non-limiting examples of a physical component include a component storage tank, a blender, a product tank, a pump, a heat exchanger, a pressure vessel, a pipe or piping system, and a valve.

“Ingredient” refers to a particular material inputted for blending of a product via a processing plant.

“Minimal trim optimization process” refers to a formula that determines a minimized amount of input ingredient(s) determined for blending with a prior blended product to satisfy specification requirements data.

“Minimized deviation” refers to a determination of minimized difference in value(s) between one or more quality property, represented by quality data, of a particular product and a product specification for a desired product, represented by specification requirements data.

“Optimized operational parameter” refers to data utilized for operating configuring one or more component(s) of a processing plant to cause production of a product based at least in part on a single-stage optimization process. In some embodiments, the optimized operational parameter includes one or more target ingredient amount(s) for one or more ingredient(s) to be blended in accordance with a single-stage optimization process.

“Preblended product” refers to a particular product produced via a first stage component based at least in part on a single-stage optimization process.

“Processing plant” refers to any building, complex, system, and/or arrangement of components that perform a chemical, physical, electrical, or mechanical process for converting input ingredient(s) into one or more output product(s). Non-limiting examples of a processing plant include a chemical processing plant and an oil refinery.

“Production” refers to operations performed by one or more physical component(s) of a processing plant that yields a particular product by blending one or more input ingredient(s).

“Quality data” refers to electronically managed data that represents one or more value(s) corresponding to one or more particular quality parameter(s) for a particular product. It will be appreciated that the quality parameter(s) may differ between particular products.

“Repeated production” refers to a process for producing a product via one or more subsequent stage component(s) of a processing plant, analysis of the qualities of the resulting product, and routing of the resulting product for subsequent production or outputting based at least in part on the qualities,

“Routing” refers to a flow of a product between components of a processing plant via one or more physical connection(s) between such components.

“Single virtual stage component” refers to a virtual representation of an aggregation of one or more components that are capable of blending products in accordance with a multi-stage blending process. In some embodiments a single virtual stage component represents a first stage component and at least one subsequent stage component.

“Single-stage optimization process” refers to a formula that determines a target ingredient amount for each of one or more ingredient(s) utilized to produce a particular product.

“Specification requirements data” refers to electronically managed data representing an acceptable value or acceptable range of values for production of a product of a particular product type.

“Specification satisfaction indicator” refers to electronically managed data that represents whether quality data associated with a particular product satisfies specification requirements data for a particular target product type. In some embodiments specification satisfaction indicator indicates satisfaction of the specification requirements data in circumstances where values for a particular quality parameter from quality data of a particular product match an acceptable value or fall within an acceptable range.

“Stage component” refers to a physical component of a processing plant that blends one or more ingredient(s), and/or one or more ingredient(s) and a previously-produced product, to produce a new product.

“Subsequent quality data” refers to quality data associated with a subsequent product produced in combination with one or more input ingredient(s) and a previously produced product.

“Subsequent specification satisfaction indicator” refers to a specification satisfaction indicator associated with a particular subsequent stage product.

“Subsequent stage component” refers to a component of a processing plant that processes a previously-blended product determined not to satisfy specification requirements data together with one or more input ingredient(s) to produce an updated product attempted to satisfy the specification requirements data.

“Subsequent stage product” refers to a product that is based at least in part on a previously-produced product and one or more input ingredient(s), and that is produced by a second or later stage component of a multi-stage blending process.

“Target ingredient amount” refers to a determined volume, percentage, and/or absolute amount of a particular ingredient or multiple ingredients to be mixed to produce a particular product from a combination of ingredients or from a combination of a previously-produced product and one or more ingredient(s). In some embodiments, a target ingredient amount embodies an optimized operational parameter generated by a single-stage optimization process or a minimal trim optimization process.

“Virtual representation” refers to electronically managed data that represents an abstraction of operation of one or more physical component(s) of a processing plant, and/or an aggregation of one or more physical component(s) of the processing plant.

### Overview

In various contexts, a processing plant is utilized to create one or more particular product. One such example context of a processing plant includes an oil refinery that processes various input ingredients to create one or more types of oil-based products. Each may be defined by particular specification(s) that define qualities that the product must have to be considered of the particular desired product type. For example, a particular type of gasoline may correspond to a particular specification that defines an octane number, autoignition temperature, and/or the like that defines the different product types for different uses.

Many of such processing plants may use a multi-stage process to create a particular product. Continuing the example of an oil refinery, for example, such an oil refinery may utilize a multi-stage blending process to create a final product for lifting by a customer. The multi-stage blending process includes an initial, first stage blending process performed via a first tank or blender, which creates a preblended product. The preblended product may be produced with particular input ingredients with the intent to satisfy a particular product specification (“specification”). Often, however, error(s), existing product remnant in the tank (e.g., heel), and/or other external or unpredictable factors may impact the preblended product such that it does not satisfy all aspects of the particular specification. The preblended product that fails to satisfy all aspects of the specification may subsequently be routed to another component, for example a different blender, tank, and/or the like, via which a subsequent blending stage is performed with new amounts of input ingredient(s) to attempt to adjust the product in a manner that satisfies the specification.

The use of multi-stage blending processes, though beneficial, cause particular difficulties with respect to optimizing operation of the processing plant utilizing one or more particular optimization process(es). For example, certain optimization processes that model based on a physical layout of the processing plant may be unusable or inaccurate when attempting to model in accordance with a multi-stage blending process. Indeed, in various circumstances, an optimization process performed for a particular processing plant configured for multi-stage blending processing often will yield inefficient or incorrect optimal recipes for producing a particular product. Other optimization processes may fail to address optimal operation of subsequent stages in the multi-stage blending process, reducing the effectiveness and diminishing the purpose of performing the optimization process.

Embodiments of the present disclosure provide for optimization for operation of a processing plant configured in accordance with a multi-stage blending process. Such embodiments optimize operation of the processing plant for producing particular product(s), for example at each stage of the multi-stage blending process. Some embodiments generate a virtual representation that includes an aggregation of a plurality of different stage components of the processing plant into a single virtual stage component. The virtual representation may be maintained to eliminate consideration of such subsequent stage components individually. Some such embodiments further generate at least one optimized operational parameter utilizing a single-stage optimization process based at least in part on the virtual representation. The optimized operational parameter may be utilized by a first component to produce a preblended product. Some such embodiments further cause production, via at least a first stage component of the plurality of components of the processing plant, of a preblended product with minimized deviation from the at least one optimized operational parameter. The preblended product may be processed to determine whether the produced product requires subsequent processing, for example based on any unexpected effects on the product. Some such embodiments further generate a specification satisfaction indicator by determining whether quality data corresponding to the preblended product satisfies specification requirements data. The specification satisfaction indicator represents whether the product is associated with particular qualities that satisfy a corresponding specification for the product to be produced. Some such embodiments further cause routing of the preblended product based at least in part on the specification satisfaction indicator.

The routing of the product is similarly optimized by embodiments of the disclosure. In a circumstance where the specification satisfaction indicator indicates that the specification is satisfied, some such embodiments may route the produced product for outputting, for example for lifting to a customer. In a circumstance where the specification satisfaction indicator indicates that the specification is not satisfied, some such embodiments may route the produced product for processing in a subsequent stage via subsequent stage component. The subsequent stage component may produce a subsequent stage product, for example via blending with one or more other input ingredient(s) blended with the preblended product. The subsequent stage component may blend the ingredient(s) based at least in part on a minimal trim optimization process separate from the single-stage optimization process, which optimizes subsequent input ingredients to be blended with the preblended product to satisfy the specification. The resulting subsequent stage product may then similarly be processed to determine whether the specification is satisfied and the subsequent stage product may be output, or whether further processing of the subsequent stage product is required to satisfy the specification.

Subsequent stages of the processing may be performed to iteratively update the product, if required. Utilizing the minimal trim optimization process, repeated iterations of subsequent stage processing updates the product in a manner that remains optimized. In this regard, embodiments operate the processing plant in an improved and optimized manner over existing operation of a processing plant.

### Example Systems and Apparatuses of the Disclosure

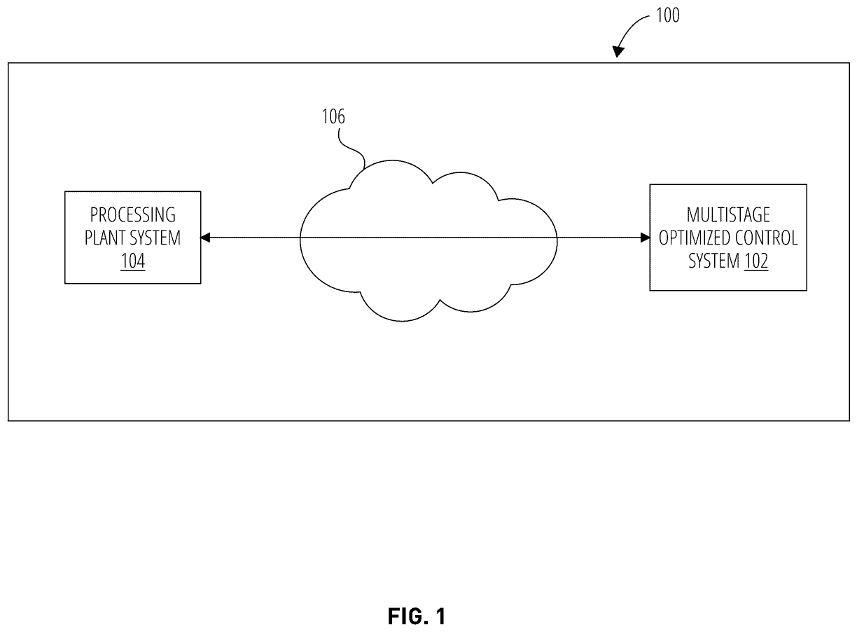

FIG. 1 illustrates a block diagram of a system that may be specially configured within which embodiments of the present disclosure may operate. Specifically, FIG. 1 depicts an example system 100. As illustrated, the system 100 includes a multistage optimized control system 102 in communication with a processing plant system 104. In some embodiments, the multistage optimized control system 102 is embodied by or as a sub-system of the processing plant system 104. In some embodiments, the multistage optimized control system 102 communicates with the processing plant system 104 over one or more communication network(s), for example a communications network 106.

It should be appreciated that the communications network 106 in some embodiments is embodied in any of a myriad of network configurations. In some embodiments, the communications network 106 embodies a public network (e.g., the Internet). In some embodiments, the communications network 106 embodies a private network (e.g., an internal localized, or closed-off network between particular devices). In some other embodiments, the communications network 106 embodies a hybrid network (e.g., a network enabling internal communications between particular connected devices and external communications with other devices). The communications network 106 in some embodiments includes one or more base station(s), relay(s), router(s), switch(es), cell tower(s), communications cable(s) and/or associated routing station(s), and/or the like. In some embodiments, the communications network 106 includes one or more user controlled computing device(s) (e.g., a user-owned router and/or modem) and/or one or more external utility devices (e.g., Internet service provider communication tower(s) and/or other device(s)).

Each of the components of the system 100 communicatively coupled to transmit data to and/or receive data from one another over the same or different wireless and/or wired networks embodying the communications network 106. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 106, the various embodiments are not limited to this architecture. In other embodiments, one or more computing entities share one or more components, hardware, and/or the like, or otherwise are embodied by a single computing device such that connection(s) between the computing entities are over the communications network 106 are altered and/or rendered unnecessary. For example, in some embodiments, the processing plant system 104 includes some or all of the multistage optimized control system 102, such that an external communications network 10 is not required.

In some embodiments, the multistage optimized control system 102 and the processing plant system 104 are embodied in an on-premises system within or associated with the processing plant. In some such embodiments, the multistage optimized control system 102 and the processing plant system 104 are communicatively coupled via at least one wired connection. Alternatively or additionally, in some embodiments, the processing plant system 104 embodies or includes the multistage optimized control system 102, for example as a software component of a single enterprise terminal.

The processing plant system 104 includes any number of computing device(s), system(s), physical component(s), and/or the like, that facilitates producing of any number of products, for example utilizing particular configurations that cause processing of particular ingredients available within the processing plant system 104. In some embodiments, the processing plant system 104 includes one or more physical component(s), connection(s) between physical component(s), and/or computing system(s) that control operation of each physical component therein. In one example context, the processing plant system 104 embodies an oil refinery, which includes physical component(s) embodying rundown blender(s), batch blender(s), product tank(s), or other component(s) that perform particular process(es) to alter properties of inputs to the component, crude flow unit(s), piping between such physical component(s), valve(s) controlling flow between the physical component(s), and/or the like. Additionally or alternatively, in some embodiments the processing plant system 104 includes one or more computing system(s) that are specially configured to operate the physical component(s) in a manner that produces one or more particular product(s) simultaneously. In some embodiments, a processing plant system 104 includes one or more computing device(s) and/or system(s) embodied in hardware, software, firmware, and/or a combination thereof, that configure and/or otherwise control operation of one or more physical component(s) in the processing plant. For example, in some embodiments, such computing device(s) and/or system(s) include one or more programmable logic controller(s), MPC(s), application server(s), centralized control system(s), and/or the like, that control(s) configuration and/or operation of at least one physical component. It will be appreciated that different processing plant system(s) may include or otherwise be associated with different physical component(s), computing system(s), and/or the like. For example, different refinery plants may include different components, different number of components, different types of components, and/or the like, that cause the processing plant system to operate differently from other processing plants.

The multistage optimized control system 102 includes one or more computing device(s) and/or system(s) embodied in hardware, software, firmware, and/or a combination thereof, that generate one or more optimized operational parameter(s), for example associated with a final product produced from a combination of ingredients(s). In some embodiments, the multistage optimized control system 102 generates optimized operational parameter(s) particular one or more stage component(s) of a processing plant, for example utilizing a single virtual stage component generated as a virtual representation of the aggregation of the one or more stage component(s). Additionally or alternatively, in some embodiments the multistage optimized control system 102 generates at least one optimized operational parameter utilizing a single-stage optimization process based at least in part on the virtual representation. Additionally or alternatively, in some embodiments, the multistage optimized control system 102 causes controlling of the processing plant, for example embodied by or as part of the processing plant system 104 to cause production of a first product, such as a preblended product, based at least in part on the at least one optimized operational parameter. Additionally or alternatively, the multistage optimized control system 102 in some embodiments generates a specification satisfaction indicator based at least in part on the first product, and causes routing of the produced product based at least in part on such a specification satisfaction indicator, for example for subsequent processing and/or outputting. Additionally or alternatively, in some embodiments, the multistage optimized control system 102 includes one or more client device(s), user device(s), and/or the like, that enable access to the functionality provided via the multistage optimized control system 102, for example via a web application, a native application, and/or the like executed on the client device.

In some embodiments, the multistage optimized control system 102 is configured to perform a multistage pre-blending optimization process that predicts optimized operational parameter(s) associated with a production of final products utilizing one or more stages of blending via a plurality of stage components utilizing ingredient(s) available within a processing plant. For example, in some embodiments, the multistage optimized control system 102 is configured to utilize a single-stage optimization process that performs generation of optimized operational parameter(s) in a manner that optimizes target ingredient amount(s) of ingredient(s) at various stages of a multi-stage enabled processing plant in a manner that optimizes particular target parameters. Additionally or alternatively, in some embodiments, the optimized operational parameter(s) is configured to output the at least one optimized operational parameter(s), for example to a system corresponding to the processing plant, such as processing plant system 104. Additionally or alternatively, in some embodiments, the multistage optimized control system 102 is utilized to control operation of one or more physical component(s) in a processing plant. In some embodiments, the multistage optimized control system 102 includes or embodies one or more display(s) and/or other user interface(s) to which a user-facing interface is renderable.

In some embodiments, the multistage optimized control system 102 and the processing plant system 104 communicate with one another to perform the various actions described herein. For example, in some embodiments, the multistage optimized control system 102 and the processing plant system 104 communicate to generate, and/or transmit for use, one or more optimized operational parameter(s) associated with operation of a particular processing plant, and/or particular sub-components (e.g., physical component(s)) thereof. Additionally or alternatively, in some embodiments, the multistage optimized control system 102 and the processing plant system 104 communicate to facilitate control or adjustment of operation of physical component(s) in the processing plant based at least in part on the generated optimized operational parameter(s). For example, in some embodiments, the multistage optimized control system 102 and processing plant system 104 communicate to configure one or more physical component(s), such as blender(s), of the processing plant to ensure production of particular final product(s) having particular qualities based at least in part on the optimized operational parameter(s).

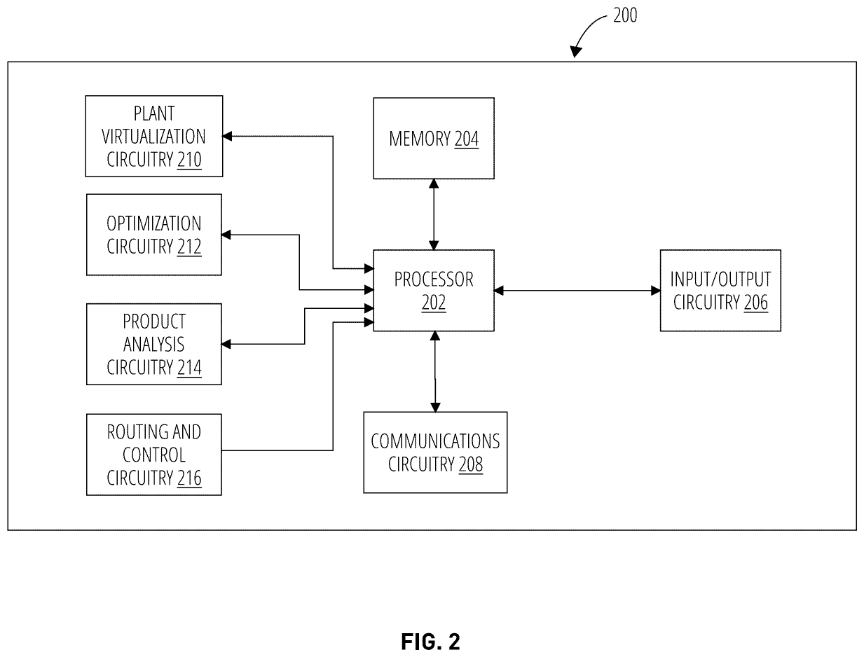

FIG. 2 illustrates a block diagram of an example apparatus that may be specially configured in accordance with an example embodiment of the present disclosure. Specifically, FIG. 2 depicts an example multistage pre-blending optimization apparatus 200 (“apparatus 200”) specially configured in accordance with at least some example embodiments of the present disclosure. In some embodiments, the multistage optimized control system 102 and/or a portion thereof is embodied by one or more system(s), for example embodied by the apparatus 200 as depicted and described in FIG. 2. The apparatus 200 includes processor 202, memory 204, input/output circuitry 206, communications circuitry 208, plant virtualization circuitry 210, optimization circuitry 212, product analysis circuitry 214, and/or routing and control circuitry 216. In some embodiments, the apparatus 200 is configured, using one or more of the sets of circuitry 202, 204, 206, 208, 210, 212, 214, and/or 216, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with plantwide optimization with multistage pre-blending. In some embodiments, the processor 202 includes hardware, software, firmware, and/or a combination thereof, that generates a virtual representation of a processing plant, which includes an aggregation of a plurality of stage components into a single virtual stage component. Additionally or alternatively, in some embodiments, the processor 202 includes hardware, software, firmware, and/or a combination thereof, that generates at least one optimized operational parameter utilizing at least one single stage single-stage optimization process, for example based at least in part on the virtual representation. Additionally or alternatively, in some embodiments, the processor 202 includes hardware, software, firmware, and/or a combination thereof, that causes production of a predefined product based at least in part on the optimized operational parameter, for example with minimized deviation from the at least one optimized operational parameter. Additionally or alternatively, in some embodiments, the processor 202 includes hardware, software, firmware, and/or a combination thereof, that generates a specification satisfaction indicator by determining whether quality data corresponding to the preblended product satisfies specification requirements data. Additionally or alternatively, in some embodiments, the processor 202 includes hardware, software, firmware, and/or a combination thereof, that causes routing of the preblended product based at least in part on the specification satisfaction indicator.

In some embodiments, the apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application, for example provided to a client side device, to provide input/output functionality to the client device and/or other display associated with a user.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

The plant virtualization circuitry 210 includes hardware, software, firmware, and/or a combination thereof, that supports generation and/or maintenance of at least one virtual representation of at least a portion of a processing plant. For example, in some embodiments, the plant virtualization circuitry 210 includes hardware, software, firmware, and/or a combination thereof, that receives and/or identifies data representing particular physical component(s) of a processing plant, and/or connections thereof. Additionally or alternatively, in some embodiments, the plant virtualization circuitry 210 includes hardware, software, firmware, and/or a combination thereof, that generates a virtual representation of a processing plant by at least performing a process that aggregates a plurality of stage components of a processing plant into a virtual stage component. Additionally or alternatively, in some embodiments, the plant virtualization circuitry 210 includes hardware, software, firmware, and/or a combination thereof, that maintains and/or stores data embodying the virtual representation of the stage components of the processing plant. It will be appreciated that the actual components represented in the virtual representation may differ from the actual physical components in the physical layout of the processing plant, for example where the single virtual stage component represents an aggregation of the plurality of stage components into one virtual component within the virtual representation. In some embodiments, the plant virtualization circuitry 210 includes a separate processor, specially configured field programmable gate array (FPGA), or a specially programmed application specific integrated circuit (ASIC).

The optimization circuitry 212 includes hardware, software, firmware, and/or a combination thereof, that supports performance of at least one optimization process for a multistage blending processing plant. For example, in some embodiments, the optimization circuitry 212 includes hardware, software, firmware, and/or a combination thereof, that generates at least one parameter associated with operation of a processing plant in accordance with at least one optimization process. Additionally or alternatively, in some embodiments, the optimization circuitry 212 includes hardware, software, firmware, and/or a combination thereof, that generates at least one optimized operational parameter utilizing at least one single-stage optimization process, for example based at least in part on a virtual representation of a processing plant that represents aggregation of a plurality of stage components into a single virtual stage component. Additionally or alternatively, in some embodiments, the optimization circuitry 212 includes hardware, software, firmware, and/or a combination thereof, that generates supplemental optimized operational parameter(s) based at least in part on a minimal trim optimization process. In some embodiments, the optimization circuitry 212 includes a separate processor, specially configured field programmable gate array (FPGA), or a specially programmed application specific integrated circuit (ASIC).

The product analysis circuitry 214 includes hardware, software, firmware, and/or a combination thereof, that collects data representing particular quality aspect(s) of a product and/or performs particular determinations based on such data based at least in part on such data representing the particular quality aspect(s). For example, in some embodiments, the product analysis circuitry 214 includes hardware, software, firmware, and/or a combination thereof, that collects quality data associated with a particular product from at least one physical component of a processing plant. In some such embodiments, the optimization circuitry 212 includes one or more sensor(s) that are configured to collects sensor data representing at least a portion of quality data from a product in a physical component of a processing plant. Additionally or alternatively, in some embodiments, the product analysis circuitry 214 includes hardware, software, firmware, and/or a combination thereof, that identifies specification requirements data for a particular product, for example predetermined specification requirements data and/or determined specification requirements data based at least in part on a current operational mode of a processing plant and/or physical component thereof. Additionally or alternatively, in some embodiments, the product analysis circuitry 214 includes hardware, software, firmware, and/or a combination thereof, that determines whether quality data corresponding to a particular product satisfies specification requirements data. In some such embodiments, the product analysis circuitry 214 includes hardware, software, firmware, and/or a combination thereof, that compares one or more portion(s) of quality data associated with a product to one or more corresponding portions of specification requirements data. Additionally or alternatively, in some embodiments, the product analysis circuitry 214 includes hardware, software, firmware, and/or a combination thereof, that generates a specification satisfaction indicator associated with a particular product, for example based at least in part on whether quality data of a particular product satisfies specification requirements data for the particular product. Additionally or alternatively, in some embodiments, the product analysis circuitry 214 includes hardware, software, firmware, and/or a combination thereof, that collects subsequent quality data, determines whether subsequent quality data satisfies specification requirements data for a particular product, and/or generates a subsequent specification satisfaction indicator, In some embodiments, the product analysis circuitry 214 includes a separate processor, specially configured field programmable gate array (FPGA), or a specially programmed application specific integrated circuit (ASIC).

The routing and control circuitry 216 includes hardware, software, firmware, and/or a combination thereof, that supports operation of physical component(s) of a processing plant based at least in part on generated and/or determined data. For example, in some embodiments, routing and control circuitry 216 includes hardware, software, firmware, and/or a combination thereof, that causes production of a product via at least one component of a processing plant. In some such embodiments, the routing and control circuitry 216 includes hardware, software, firmware, and/or a combination thereof, that causes operation of a particular stage component, or other physical component(s) of a processing plant, to cause production of a particular product based at least in part on at least one optimized operational parameter. Additionally or alternatively, in some embodiments, routing and control circuitry 216 includes hardware, software, firmware, and/or a combination thereof, that causes flow of a particular amount of ingredient(s) into a particular physical component of a processing plant for production of a particular product. Additionally or alternatively, in some embodiments, routing and control circuitry 216 includes hardware, software, firmware, and/or a combination thereof, that causes routing of a particular product to a particular destination component of the processing plant. In some such embodiments, the routing and control circuitry 216 includes hardware, software, firmware, and/or a combination thereof, that causes routing of a product based at least in part on a specification satisfaction indicator and/or subsequent specification satisfaction indicator that indicates whether specification requirements data was satisfied, for example to a subsequent stage component or an output component of the processing plant. In some embodiments, the routing and control circuitry 216 includes a separate processor, specially configured field programmable gate array (FPGA), or a specially programmed application specific integrated circuit (ASIC).

Additionally or alternatively, in some embodiments, two or more of the sets of circuitries 202-216 are combinable. Alternatively or additionally, in some embodiments, one or more of the sets of circuitry perform some or all of the functionality described associated with another component. For example, in some embodiments, two or more of the sets of circuitry 202-216 are combined into a single module embodied in hardware, software, firmware, and/or a combination thereof. Similarly, in some embodiments, one or more of the sets of circuitry, for example the plant virtualization circuitry 210, optimization circuitry 212, product analysis circuitry 214, and/or routing and control circuitry 216, is/are combined with the processor 202, such that the processor 202 performs one or more of the operations described above with respect to each of these sets of circuitry 210-216.

### Example Processing Plant Representations of the Disclosure

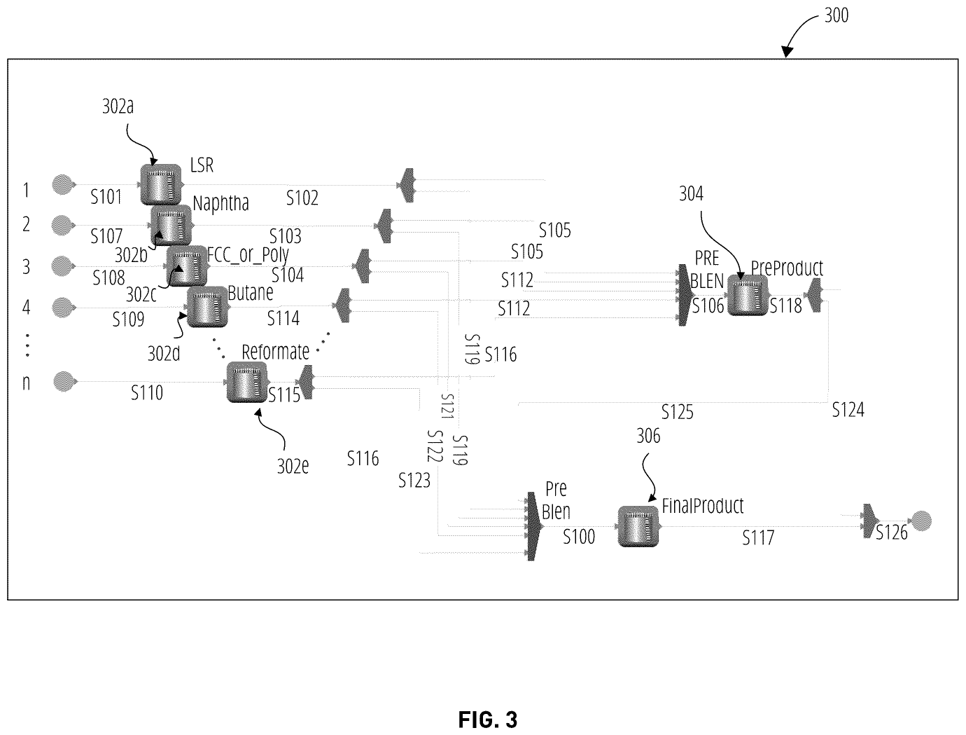

FIG. 3 illustrates a flowsheet model of a physical layout of an example processing plant configured for multi-stage operation in accordance with at least an example embodiment of the present disclosure. Specifically, FIG. 3 depicts an example representation 300 of a processing plant in a flow sheet model, with each element of the flowsheet model corresponding to a particular physical component of a processing plant. As illustrated, the example processing plant is an oil refinery. It will be appreciated that in other embodiments, other processing plants may be utilized.

The representation 300 includes a plurality of representations of components. In some embodiments, each representation is embodied by an element (e.g., an interface element) within the flowsheet model as depicted. Each element may represent a particular physical component within the processing plant itself, or a virtualized abstraction of a physical component operating in a particular mode, for example. Additionally, the flowsheet model may define connections between said components. In this regard, products may flow between such components based at least in part on such connections, for example for use in producing one or more product(s) via particular component(s) within the processing plant represented within the representation 300. The product(s) may be produced via any number of processing stages performed between one or more stage component(s) of the processing plant represented within the representation 300.

As illustrated, the representation 300 includes representations 302a-302e. The representations depicted in representation 300 includes a representation of various tanks of a processing plant, for example each representing an intermediary product tank and/or processing unit. In some embodiments, the product tanks and/or processing units depicted in the representations 302a-302e correspond to sources of a particular ingredient, such that these components embody input components (“input component 302a-302e”) in a process for producing a final product. In this regard, the input components 302a-302e source a particular ingredient having particular qualities, where the ingredient is utilized as input to a subsequent component, and/or process incoming ingredients in a particular manner. For example, as illustrated, the input components 302a-302e include crude flow units, hydro treating processing units, reforming processing units, isomerization processing units, aromatics reduction processing units, and the like, and/or tanks for storing the product resulting from such processes. Such input components 302a-302e are depicted as connected via physical connections to one or more downstream unit(s). It will be appreciated that the number, type, and/or configuration of such input components 302a-302e may be included in any particular arrangement within a processing plant.

As illustrated in the representation 300, in some embodiments, one or more of the input components 302a-302e each flow into one or more stage component(s). Specifically, representation 300 includes representations of stage component 304 and stage component 306. As illustrated, the stage component 304 embodies a first stage component, with the stage component 306 representing a subsequent stage component. In some embodiments, the stage component 304 and stage component 306 embody at least one tank and/or blender that is configured to blend product and/or store the resulting blended product. Non-limiting examples of the stage component 304 or stage component 306 include a batch blender or a rundown blender.

The stage component 304 may be configured to produce a particular target product, for example based at least in part on a plurality of ingredients from one or more input components. In this regard, in some such embodiments, the stage component 304 is connected to input components 302a-302e to enable a flow of ingredients from the input components 302a-302e to the stage component 304 for blending. A controller may control the flow of the ingredient, amounts and/or ratios thereof, to the stage component 304 to facilitate production of a particular product having particular qualities. At a particular time slice, the tank may be configured to include or otherwise produce a particular target product based on any combination of ingredient represented by the output of input component 302a-302e. In this regard, each blender may serve as a processing unit and/or final storage for a particular type of product.

The stage component 306 in some embodiments includes or is embodied by a downstream component, such as a subsequent blender, tank, and/or the like. In some embodiments, the stage component 306 is configured to produce a target product from a plurality of input components and a preblended product produced via a previous stage component. For example, in some embodiments, the stage component 306 receives a preblended product from the stage component 304. The stage component 306 may be configured to refine the preblended product utilizing, one or more ingredient(s), into the particular target product. In some embodiments, the stage component 306 is connected to another subsequent stage component, to which the preblended product from the stage component 306 may flow for further processing. Alternatively or additionally, in some embodiments, the preblended product may be further processed by the stage component 306 to refine the resulting product from the previous iteration into the target product as a final product. In this regard, in some embodiments the stage component 306 may repeat iteratively processing a product until quality data associated with that product satisfies specification requirements data.

Additionally or alternatively, in some embodiments, the stage component 304 and/or stage component 306 may be connected to an output. In this regard, the stage component 306 and/or stage component 306 may output the product stored by either of such components upon determination that quality data associated with the product satisfies specification requirements data. In some such embodiments, the final product outputted from either of such components 304 and/or 306 is stored in a tank for subsequent lifting, and/or output to a customer vessel for lifting.

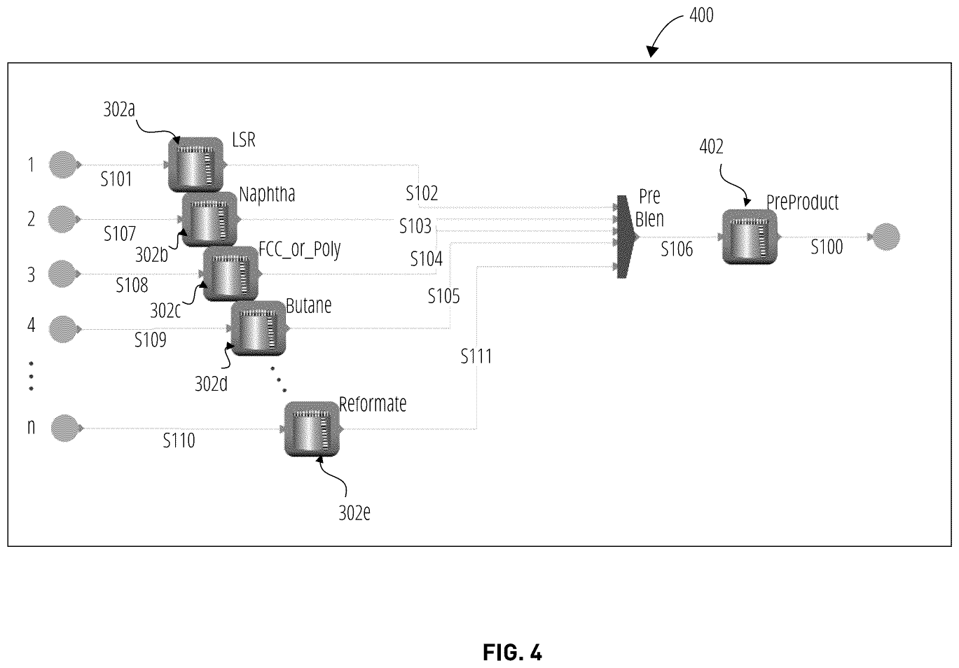

FIG. 4 illustrates a flow sheet model of an example processing plant configured for multi-stage operation virtualized for optimization in accordance with at least an example embodiment of the present disclosure. Specifically, FIG. 4 depicts an example representation 400 of a processing plant in a flow sheet model, specifically the processing plant depicted and described with respect to FIG. 3. Representation 400 includes or otherwise embodies a virtualized version of the representation 300, with one or more stage components represented in the representation 300 corresponding to a virtual representation embodying a single virtual stage component. It will be appreciated that the similarly numbered elements 302a-302e may similarly represent the components as depicted and described with respect to FIG. 3.

The representation 400 includes a single virtual stage component 402. The single virtual stage component 402 includes an aggregation of a plurality of stage components of the processing plant into a single virtual stage component. In some embodiments, for example, the single virtual stage component 402 includes an aggregation of the stage component 304 and stage component 306 as depicted and described with respect to FIG. 3. It will be appreciated that, in some embodiments, a single virtual stage component may represent three or more individual stage component(s). In some embodiments, the aggregation of the plurality of stage components embodies a mathematical combination and/or formula that ignores the influence of any subsequent stage component that is not the first stage component of the processing plant. Alternatively or additionally, in some embodiments, the aggregation of the plurality of stage components embodies a mathematical combination and/or formula that combines the characteristics of the first stage component together with each of the one or more subsequent stage components of a particular processing plant. In some embodiments, the single virtual stage component 402 is generated based at least in part on the element corresponding to each of the stage components of the flowsheet model representing the physical components of the processing plant, for example the representation 300.

In one example context, consider a multi-stage blending process performed by a first, initial stage blender and a second, subsequent stage blender. In a circumstance where the initial stage blender blends a first amount (“X”) of a first input ingredient (I₁) and a second amount (“Y”) of a second input ingredient (I₂), the first blender may be mathematically represented as producing a first product (“A”) represented by A=X/(X+Y)+Y/(X+Y). For example, 1 barrel of I₁ and 1 barrel of the I₂ would cause the blender to produce a product A where A=½ (I₁)+½ (I₂). Continuing this example, a second stage blender may, for each unit of the first product A inputted into the second stage blender, a third amount (“U”) of the first input ingredient I₁ and a fourth amount (“V”) of the second input ingredient I₂ to produce a second product (“B”). In this regard, the second blender may be mathematically represented as producing a second product represented by B=U/(U+V)+V/(U+V). For example, blending 2 barrels of I₁ for each unit of A and 3 barrels of I₂ for each unit of A, when accounting for the barrel input amounts of the initial stage blender, thus is equivalent to mixing product B from 2 barrels of A with 4 additional barrels of I₁ and 6 additional barrels of I₂ at the second stage (e.g., the subsequent blending stage). Utilizing these example configurations of the first blender and the second blender, the multi-stage blenders may be aggregated into a single virtual representation that mathematical represents the specification for a final product (“F”) where F= 5/12 I₁+ 7/12 I₂. In this regard, such a formula represents an aggregation of the initial stage blender and the subsequent stage blender into a single virtual representation, which is both mathematically and functionality identical to the original multi-stage blending representation. Such an aggregation may be extended to any number of stages to aggregate the multi-stage blending process into a single stage virtual representation that encapsulates each stage of the multi-stage blending process.

In some embodiments, the representation 400 including the virtual representation(s) of subsequent stage component(s) is utilized for performing at least one optimization process. For example, in some embodiments, the apparatus 200 processes data associated with the representation 400 to generate optimized operational parameter(s) for generating a particular target product. For example, in some embodiments, the apparatus 200 processes the representation 400 utilizing a single-stage optimization process that generates optimized operational parameter(s) representing target ingredient amount(s). The target ingredient amount(s), in some embodiments, are utilized to control a particular stage component to generate a particular product, where the product produced embodies a preblended product that is intended to embody a particular target product having particular target qualities. The optimized operational parameters may represent such target ingredient amount(s), and/or corresponding values for controlling a stage component, in a manner that optimizes particular metrics, values, and/or the like, for example resource expenditure, plant profitability, and/or the like.

In some embodiments, the apparatus 200 analyzes one or more aspects of the preblended product to determine whether the preblended product sufficiently embodies the target product. For example, in some embodiments, the apparatus 200 may identify quality data associated with the preblended product, and determine whether that quality data satisfies specification requirements data corresponding to the target product. The qualities of the preblended product may be affected by any of a myriad of controllable and/or uncontrollable effects. For example, in some embodiments, the preblended product being produced by a stage component is affected by fluctuations caused by physical forces, influences, and/or other disturbances experienced by the stage component, upstream component(s), connection(s), and/or the like, for example caused by environmental effects. In this regard, the apparatus 200 may determine that the quality data associated with the preblended product fails to satisfy specification requirements data, and thereby does not sufficiently embody a desired target product. The optimized operational parameter(s) thus generated via the single-stage optimization process enables optimization of the operation of the processing plant with optimization of one or more particular target parameter(s) without undue impact of the subsequent stage component(s) on the single-stage optimization process.

In some embodiments, the apparatus 200 utilizes each of the representations 300 and 400. For example, in some embodiments, the apparatus 200 utilizes the representation 400 to perform a particular optimization process, such as a single-stage optimization process that generates optimized operational parameter(s) intended to produce a particular product satisfying specification requirements data defining a final product of a particular type. Additionally or alternatively, in some embodiments the apparatus 200 utilizes the representation 300 to initiate control of particular components of the processing plant (e.g., to cause production of a product utilizing particular ingredient(s), identifying and/or analyzing quality data associated with the produced product, cause routing of a resulting product, further initiate control a subsequent stage component to produce a subsequent stage product, identifying and/or analyzing subsequent quality data associated with the produced subsequent stage product, cause routing of the subsequent stage product, and/or the like. For example, in some embodiments, the apparatus 200 processes the representation 300 to perform action(s) via the components associated with the processing plant, and utilizes the representation 400 to perform at least an initial optimization process (e.g., a single-stage optimization process) associated with the processing plant.

### Example Optimization Processes of the Disclosure

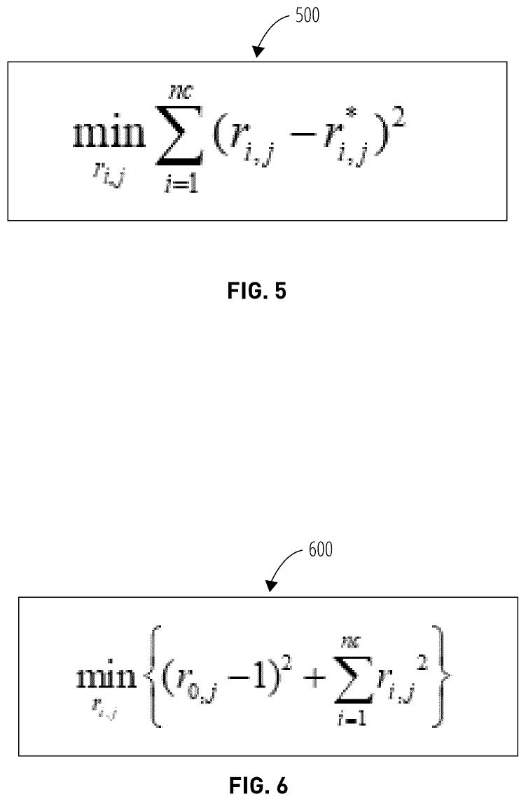

FIG. 5 illustrates an example implementation of a single-stage optimization process in accordance with at least an example embodiment of the present disclosure. Specifically, FIG. 5 illustrates an example formula embodying an example single-stage optimization process 500. In some embodiments, the apparatus 200 is configured to perform the single-stage optimization process 500 during an initial optimization process. In some embodiments, the apparatus 200 performs the initial optimization process to generate optimized operational parameter (a) utilized in producing an initial product. The initial product may utilize the optimized operational parameter(s) generated via the single-stage optimization process 500 to produce the product in a manner that optimizes one or more particular target value(s), for example by minimizing a particular target value, maximizing a particular target value, and/or performing some combination thereof, and is determined to produce the product having particular qualities (e.g., corresponding to a particular desired target product). In some embodiments, the product actually produced may fail to satisfy one or more quality requirements defined by specification requirements data, for example due to environmental impacts, error(s) in operation of one or more component(s) of the processing plant, and/or the like, such that the produced product embodies a preblended product for further processing in a subsequent stage. Alternatively, in some embodiments, the product actually produced may satisfy all quality requirements defined by the specification requirements data, such that the produced product embodies a preblended product that is prepared for outputting from the processing plant (e.g., via a lifting schedule, delivery to a customer vessel, and/or the like).

In some embodiments, for example as illustrated, r* corresponds to a particular determined optimal recipe for a particular final product. In this regard, the optimal recipe r* may represent particular target ingredient amount(s) utilized to produce a particular target product in a manner that is determined to optimize one or more particular target parameter(s) (e.g., an overall profitability of the corresponding processing plant). The apparatus 200 may enforce a minimal distance between the optimal recipe and the actual recipe being inputted via the physical component(s) of the processing plant during production of a particular target product. In some embodiments, r* represents a particular quality vector that defines qualities for a particular target product to be produced. In this regard, the single-stage optimization process 500 may be utilized to enforce a minimal distance from the target qualities represented by r* to the actual qualities based on the recipe being inputted via the physical component(s) of the processing plant during production of a particular target product.

FIG. 6 illustrates an example implementation of a minimal trim optimization process in accordance with at least an example embodiment of the present disclosure. Specifically, FIG. 6 illustrates an example formula embodying a minimal trim optimization process 600. In some embodiments, the apparatus 200 is configured to perform the minimal trim optimization process 600 during a subsequent optimization process, for example during a subsequent stage of a multi-stage blending process utilizing a subsequent stage component of a processing plant. In some embodiments, the minimal trim optimization process 600 is utilized by the subsequent stage component in production of a subsequent stage product.

The apparatus 200 for example may utilize optimized operational parameter(s) generated via the minimal trim optimization process 600 to produce a subsequent stage product in a manner that further optimizes one or more target value(s). For example, in some embodiments the minimal trim optimization process 600 similarly minimizes a particular target value, maximizes a particular target value, and/or performing some combination thereof. The minimal trim optimization process 600 may additionally be performed to produce the subsequent stage product having particular qualities corresponding to a desired target product, for example as represented by specification requirements data.

In some embodiments, the subsequent stage product produced by the subsequent stage component may fail to satisfy one or more quality requirements defined by the specification requirements data (e.g., based at least in part on the subsequent quality data identified associated with the produced subsequent stage product). In some such embodiments, the subsequent stage component may initiate another iteration of a minimal trim optimization process to further update the product into conformity with the specification requirements data. In some other embodiments, the subsequent stage component routes the subsequent stage product to another subsequent stage component for further processing, for example via the minimal trim optimization process. Alternatively, in some embodiments, the subsequent stage product actually produced may satisfy all quality requirements defined by the specification requirement data (e.g., based at least in part on the subsequent quality data identified for the subsequent stage product), such that the product may be stored and/or routed for outputting from the processing plant.

In some embodiments, for example illustrated, the minimal trim optimization process 600 minimizes additional amount(s) of ingredient(s) that are blended with a preblended product to update the preblended product to satisfy the specification requirements data for a particular desired final product. For example, based at least in part on subsequent quality data corresponding to the subsequent quality data. In this regard, the minimal trim optimization process 600 may be utilized to generate subsequent optimized operational parameter(s), for example embodying subsequent target ingredient amount(s), utilized in each iteration of a subsequent stage of the multistage optimization process.

### Example Processes of the Disclosure

Having described example systems, apparatuses, data architectures, and formula implementations in accordance with the present disclosure, example processes for plantwide optimization with multistage pre-blending will now be discussed. It will be appreciated that each of the flowcharts depicts an example computer-implemented process that is performable by one or more of the apparatuses, systems, devices, and/or computer program products described herein, for example utilizing one or more of the specially configured components thereof.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

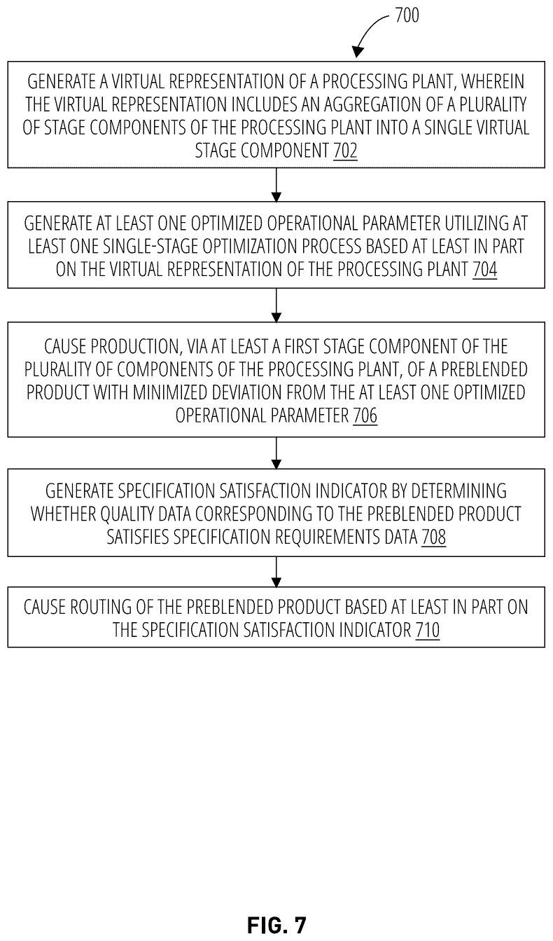

FIG. 7 illustrates a process 700 for optimizing production in a multi-stage blending configured processing plant, in accordance with an example embodiment of the present disclosure. Specifically, FIG. 7 illustrates an example computer-implemented process 700. In some embodiments, the process 700 is embodied by computer program code stored on a non-transitory computer-readable storage medium of a computer program product configured for execution to perform the process as depicted and described. Alternatively or additionally, in some embodiments, the process 700 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like to perform one or more of the operations as depicted and described. For example, the apparatus 200 in some embodiments is in communication with one or more separate processing plant system(s), physical component(s) of a processing plant, and/or the like. For purposes of simplifying the description, the process 700 is described as performed by and from the perspective of the apparatus 200. In some embodiments, the apparatus 200 performs the operations of the process 700 utilizing particular means, such as the plant virtualization circuitry 210, optimization circuitry 212, product analysis circuitry 214, routing and control circuitry 216, processor 202, memory 204, input/output circuitry 206, and/or communications circuitry 208, or a combination thereof.

The process 700 begins at operation 702. According to some examples, the method includes generating a virtual representation of a processing plant at operation 702. In some embodiments, the virtual representation includes an aggregation of a plurality of stage components of the processing plant into a single virtual stage component. In some embodiments, the single virtual stage component embodies a single element represented in a model (e.g., a flowsheet or other data model) that defines the layout of the processing plant. The aggregation of the plurality of stage components in some embodiments represents a mathematical combination of the plurality of stage components of the processing plant, and/or a particular stage component of the plurality of stage components (e.g., a first stage component that encapsulates the operations of the remaining stage components of the plurality of stage components).

According to some examples, the method includes generating at least one optimized operational parameter at operation 704. In some embodiments, the apparatus 200 generates the at least one optimized operational parameter utilizing at least one single-stage optimization process based at least in part on the virtual representation of the processing plant. For example, in some embodiments, the apparatus 200 identifies and/or otherwise utilizes a data representation corresponding to the processing plant, where the data representation includes at least the single virtual stage component. In this regard, the apparatus 200 may perform the single-stage optimization process based at least in part on the particular virtualization of the layout of the processing plant.

According to some examples, the method includes causing production, via at least a first stage component of the plurality of components of the processing plant, of a preblended product at operation 706. In some embodiments, the apparatus 200 causes production of the preblended product with minimized deviation from the at least one optimized operational parameter. For example, in some embodiments, the apparatus 200 causes production of the preblended product by facilitating inputting of particular amounts of ingredients based at least in part on target ingredient amount(s) indicated by the optimized operational parameter(s).

According to some examples, the method includes generating specification satisfaction indicator at operation 708. In some embodiments, the apparatus 200 generates the specification satisfaction indicator by determining whether quality data corresponding to the preblended product satisfies specification requirements data. In some embodiments, the specification requirements data embodies particular qualities of a particular target product to be produced, for example based at least in part on an optimal recipe for the particular target product. In some embodiments, the target product is determined based at least in part on an optimization process. Alternatively or additionally, in some embodiments, the target product is determined based at least in part on user input to the apparatus 200, for example selecting the target product from a universe of candidate target products. Alternatively or additionally still, in some embodiments, the apparatus 200 automatically determines the target product, for example based at least in part on an optimization product, for example that determines a target amount of a target product to produce to optimize one or more target parameter(s), such as profitability of the operation of the processing plant.

According to some examples, the method includes causing routing of the preblended product based at least in part on the specification satisfaction indicator at operation 710. In some embodiments, the apparatus 200 causes particular physical component(s) of the processing plant to operate in a particular manner that routes the product within the physical component(s) to a particular subsequent component and/or the like. For example, in some embodiments, the apparatus 200 causes routing of the preblended product to a particular component for outputting in a circumstance where the preblended product is determined to sufficiently embody a particular target product. Additionally or alternatively, in some embodiments, the apparatus 200 causes routing of the preblended product to a subsequent stage component in a circumstance where the preblended product is determined to not sufficiently embody a particular target product. Example implementations for causing routing of the preblended product is further described herein with respect to identification of quality data for a preblended product, determination of a specification satisfaction indicator, and/or derivation(s) associated therewith.

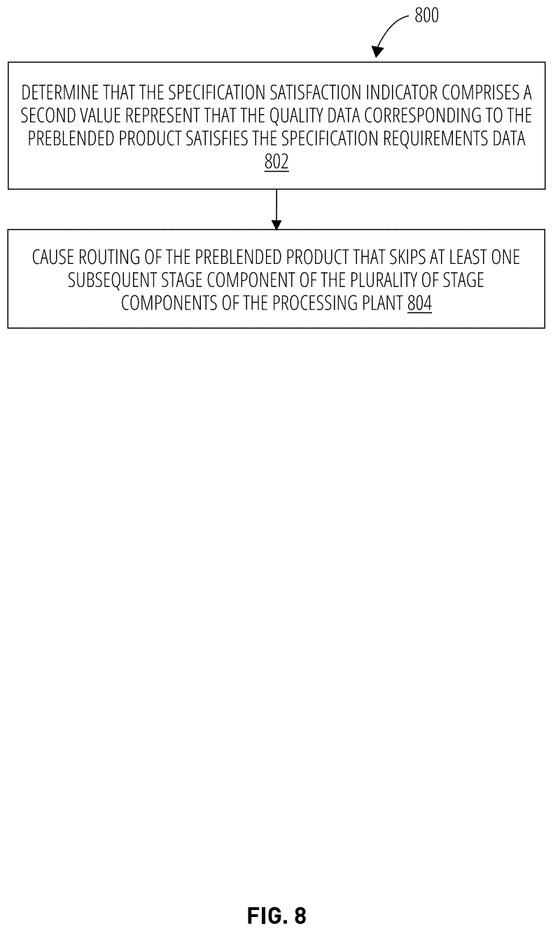

FIG. 8 illustrates a process 800 for routing of a product to skip a subsequent stage, for example as part of an example process for optimizing production in a multi-stage blending configured processing plant, in accordance with an example embodiment of the present disclosure. Specifically, FIG. 8 illustrates an example computer-implemented process 800. In some embodiments, the process 800 is embodied by computer program code stored on a non-transitory computer-readable storage medium of a computer program product configured for execution to perform the process as depicted and described. Alternatively or additionally, in some embodiments, the process 800 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like to perform one or more of the operations as depicted and described. For example, the apparatus 200 in some embodiments is in communication with one or more separate processing plant system(s), physical component(s) of a processing plant, and/or the like. For purposes of simplifying the description, the process 700 is described as performed by and from the perspective of the apparatus 200. In some embodiments, the apparatus 200 performs the operations of the process 800 utilizing particular means, such as the plant virtualization circuitry 210, optimization circuitry 212, product analysis circuitry 214, routing and control circuitry 216, processor 202, memory 204, input/output circuitry 206, and/or communications circuitry 208, or a combination thereof.

The process 800 begins at operation 802. In some embodiments, the process 800 begins after one or more operations depicted and/or described with respect to any of the other processes described herein. For example, in some embodiments as depicted, the process 800 begins after execution of the operation 708. In this regard, some or all of the process 700 may replace or supplement one or more blocks depicted and/or described with respect to any of the other processes described herein. For example, in some embodiments as depicted, the process 800 supplants, supplements, and/or otherwise replaces one or more operations of the process 700. Additionally or alternatively, as depicted, in some embodiments upon completion of the process 800 the flow returns to one or more operations of another process. For example, in some embodiments, the flow may return to operation 710 as depicted and described.

According to some examples, the method includes determining that the specification satisfaction indicator comprises a second value represent that the quality data corresponding to the preblended product satisfies the specification requirements data at operation 802. For example, in some embodiments, the apparatus 200 identifies the quality data associated with a particular product, for example the preblended product, utilizing one or more sensor(s) associated with a particular stage component, such as a first stage component of the processing plant. The sensor(s) may include any hardware, software, firmware, and/or a combination thereof, positioned in or associated with a particular blender (e.g., a stage component), that reads a value associated with one or more quality/qualities of the product produced or otherwise within the stage component. In some embodiments, the apparatus 200 compares each particular portion of the quality data with a corresponding portion of the specification requirements data. For example, in this regard the apparatus 200 may compare a portion of the quality data associated with the preblended product that corresponds to a particular quality parameter with another portion of the specification requirements data that similarly corresponds to the particular quality parameter. In some embodiments, the specification requirements data represents range(s) for a particular value corresponding to a quality to fall between for a particular product with such a quality to embody a particular product. The apparatus 200 may perform such comparisons for each quality parameter in the specification requirements data that defines a particular target product. In some such embodiments, the apparatus 200 may generate a specification satisfaction indicator of a second value indicating that quality data satisfies the specification requirements data in a circumstance where each comparison indicates that each portion of the quality data satisfies a corresponding portion of the specification requirements data.

According to some examples, the method includes causing routing of the preblended product that skips at least one subsequent stage component of the plurality of stage components of the processing plant at operation 804. For example, in some embodiments, the apparatus 200 causes routing of the preblended product to a physical component of the processing plant for outputting from the processing plant. Such a component in some embodiments includes a tank or related component that stores a final product for lifting by a customer. In this regard, the preblended product in such contexts embody a final product that skips processing of the preblended product via one or more iteration(s) performed via subsequent stage component(s) by routing the preblended product for output.

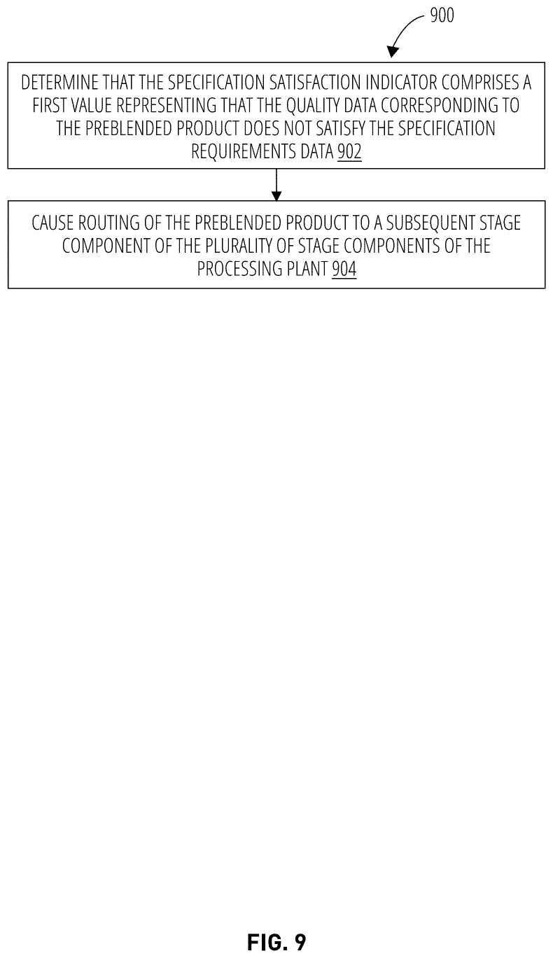

FIG. 9 illustrates a process 900 for routing a product to a subsequent stage component, for example as part of an example process for optimizing production in a multi-stage blending configured processing plant, in accordance with an example embodiment of the present disclosure. Specifically, FIG. 9 illustrates an example computer-implemented process 900. In some embodiments, the process 900 is embodied by computer program code stored on a non-transitory computer-readable storage medium of a computer program product configured for execution to perform the process as depicted and described. Alternatively or additionally, in some embodiments, the process 900 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like to perform one or more of the operations as depicted and described. For example, the apparatus 200 in some embodiments is in communication with one or more separate processing plant system(s), physical component(s) of a processing plant, and/or the like. For purposes of simplifying the description, the process 700 is described as performed by and from the perspective of the apparatus 200. In some embodiments, the apparatus 200 performs the operations of the process 900 utilizing particular means, such as the plant virtualization circuitry 210, optimization circuitry 212, product analysis circuitry 214, routing and control circuitry 216, processor 202, memory 204, input/output circuitry 206, and/or communications circuitry 208, or a combination thereof.

The process 900 begins at operation 902. In some embodiments, the process 900 begins after one or more operations depicted and/or described with respect to any of the other processes described herein. For example, in some embodiments as depicted, the process 900 begins after execution of the operation 708. In this regard, some or all of the process 700 may replace or supplement one or more blocks depicted and/or described with respect to any of the other processes described herein. For example, in some embodiments as depicted, the process 900 supplants, supplements, and/or otherwise replaces one or more operations of the process 700. Additionally or alternatively, as depicted, in some embodiments upon completion of the process 900 the flow returns to one or more operations of another process. For example, in some embodiments, the flow may return to operation 710 as depicted and described.

According to some examples, the method includes determining that the specification satisfaction indicator comprises a first value representing that the quality data corresponding to the preblended product does not satisfy the specification requirements data at operation 902. For example, in some embodiments, the apparatus 200 identifies the quality data associated with a particular product, for example the preblended product, utilizing one or more sensor(s) associated with a particular stage component, such as a first stage component of the processing plant. The sensor(s) may include any hardware, software, firmware, and/or a combination thereof, positioned in or associated with a particular blender (e.g., a stage component), that reads a value associated with one or more quality/qualities of the product produced or otherwise within the stage component. In some embodiments, the apparatus 200 compares each particular portion of the quality data with a corresponding portion of the specification requirements data. For example, in this regard the apparatus 200 may compare a portion of the quality data associated with the preblended product that corresponds to a particular quality parameter with another portion of the specification requirements data that similarly corresponds to the particular quality parameter. In some embodiments, the specification requirements data represents range(s) for a particular value corresponding to a quality to fall between for a particular product with such a quality to embody a particular product. In this regard, a quality may not be sufficient to satisfy a particular portion of specification requirements data in a circumstance where a value defined by a portion of quality data for a particular quality does not fall within the defined range of the corresponding portion of specification requirements data, for example. The apparatus 200 may perform such comparisons for each quality parameter in the specification requirements data that defines a particular target product. In some such embodiments, the apparatus 200 may generate a specification satisfaction indicator of a first value indicating that quality data does not satisfy the specification requirements data in a circumstance where at least one comparison indicates that a portion of the quality data fails to satisfy a corresponding portion of the specification requirements data (e.g., a particular value for a particular quality falls outside of an acceptable range defined by the specification requirements data).

According to some examples, the method includes causing routing of the preblended product to a subsequent stage component of the plurality of stage components of the processing plant at operation 904. For example, in some embodiments, the apparatus 200 causes routing of the preblended product to a physical component of the processing plant embodying a subsequent stage component, where the subsequent stage component performs further manipulation of the preblended product. For example, in some embodiments, the subsequent stage component modifies the preblended product based at least in part on data generated via a minimal trim optimization process, such as by inputting a particular amount of subsequent ingredients utilized to modify qualities of the preblended product. In some embodiments, the apparatus 200 causes routing of the preblended product to a subsequent stage component together with initiation of a subsequent iteration of the modifying the preblended product via a subsequent iteration of an optimization process (e.g., the minimal trim optimization process).

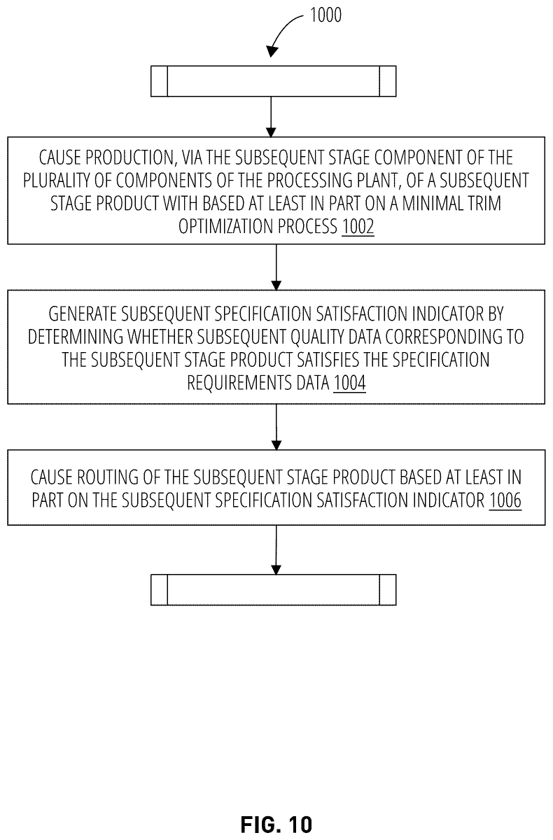

FIG. 10 illustrates a process 1000 for producing and routing a subsequent stage product, for example as part of an example process for optimizing production in a multi-stage blending configured processing plant, in accordance with an example embodiment of the present disclosure. Specifically, FIG. 10 illustrates an example computer-implemented process 1000. In some embodiments, the process 1000 is embodied by computer program code stored on a non-transitory computer-readable storage medium of a computer program product configured for execution to perform the process as depicted and described. Alternatively or additionally, in some embodiments, the process 1000 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like to perform one or more of the operations as depicted and described. For example, the apparatus 200 in some embodiments is in communication with one or more separate processing plant system(s), physical component(s) of a processing plant, and/or the like. For purposes of simplifying the description, the process 700 is described as performed by and from the perspective of the apparatus 200. In some embodiments, the apparatus 200 performs the operations of the process 1000 utilizing particular means, such as the plant virtualization circuitry 210, optimization circuitry 212, product analysis circuitry 214, routing and control circuitry 216, processor 202, memory 204, input/output circuitry 206, and/or communications circuitry 208, or a combination thereof.

The process 1000 begins at operation 1002. In some embodiments, the process 1000 begins after one or more operations depicted and/or described with respect to any of the other processes described herein. For example, in some embodiments as depicted, the process 1000 begins after execution of the operation 904. In this regard, some or all of the process 1000 may replace or supplement one or more blocks depicted and/or described with respect to any of the other processes described herein. Additionally or alternatively, as depicted, in some embodiments upon completion of the process 1000 the flow returns to one or more operations of another process.

As illustrated, the process 1000 defines a loop that is repeatable for any number of iterations. In some embodiments, for example, the process system 1000 is repeatable for each subsequent stage component to which a product is routed for further processing. In this regard, the apparatus 200 may repeat the process 1000 for any number of iterations associated with any number of subsequent stage components, such as until a particular trigger point is reached, for example a data-driven determination that a modified product satisfies specification requirements data as described herein.

According to some examples, the method includes causing production, via the subsequent stage component of the plurality of components of the processing plant, of a subsequent stage product with based at least in part on a minimal trim optimization process at operation 1002. As described herein, in some embodiments, the minimal trim optimization process determines optimized operational parameter(s) for use in operating a subsequent stage component to manipulate a product from a previous stage in an optimized manner to satisfy specification requirements data. In some embodiments, the apparatus 200 communicates directly with the subsequent stage component and/or related component(s) of the processing plant, for example to transmit control command(s) to the subsequent stage component and/or related physical component(s) of the processing plant (e.g., input product tanks including ingredients) that causes the subsequent stage component to operate in a particular manner based at least in part on the data generated via the minimal trim optimization process. Additionally or alternatively, in some embodiments, the apparatus 200 communicates with a processing plant system that facilitates transmission of command(s) to the subsequent stage component and/or related physical component(s) that controls operation of such component(s) based at least in part on the data generated via the minimal trim optimization process.

According to some examples, the method includes generating subsequent specification satisfaction indicator at operation 1004. In some embodiments, the apparatus 200 generates the subsequent specification indicator by determining whether subsequent quality data corresponding to the subsequent stage product satisfies the specification requirements data. In some embodiments, the apparatus 200 determines the subsequent quality data corresponding to the subsequent stage product utilizing one or more sensor(s) and/or the like embodied as part of, in, or otherwise communicatively coupled with the subsequent stage component. For example, in some embodiments, the apparatus 200 utilizes such sensor(s) to read quality data representing the value of particular quality parameter(s) from the subsequent stage product within the subsequent stage component. In some embodiments, the subsequent quality data is compared with the specification requirements data for a particular product to determine whether each value for a quality represented in the subsequent quality data satisfies a corresponding portion for that quality of the specification requirements data. Such identification and/or determination may be performed in a similar manner to that described above, for example with respect to operation 708. 802, and/or 902.

According to some examples, the method includes causing routing of the subsequent stage product based at least in part on the subsequent specification satisfaction indicator at operation 1006. For example, in some embodiments, the apparatus 200 causes routing of the subsequent stage product for outputting in a circumstance where the subsequent specification satisfaction indicator indicates that the subsequent quality data satisfies the specification requirements data. Alternatively, the apparatus 200 may not cause routing of the subsequent stage product, or in some embodiments may cause routing of the subsequent stage product to another subsequent stage component of the processing plant for example, in a circumstance where the apparatus 200 determines that the subsequent specification satisfaction indicator indicates that the subsequent quality data does not satisfy the specification requirements data. In this regard, the subsequent stage product may be routed in a particular manner that enables further processing to modify the product to embody a final product, for example by satisfying the specification requirements data, in one or more iterations of a multistage blending process as described herein. For example, in some embodiments such routing may be performed in a similar manner to that described above, for example with respect to operation 710, 804, and/or 904.

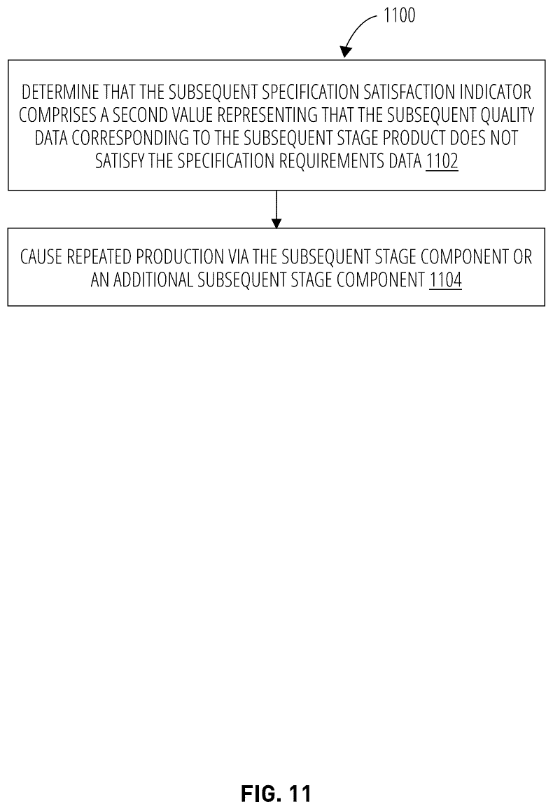

FIG. 11 illustrates a process 1100 for iterative repeated production via a plurality of subsequent stage components, for example as part of an example process for optimizing production in a multi-stage blending configured processing plant, in accordance with an example embodiment of the present disclosure. Specifically, FIG. 11 illustrates an example computer-implemented process 1100. In some embodiments, the process 1100 is embodied by computer program code stored on a non-transitory computer-readable storage medium of a computer program product configured for execution to perform the process as depicted and described. Alternatively or additionally, in some embodiments, the process 1100 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like to perform one or more of the operations as depicted and described. For example, the apparatus 200 in some embodiments is in communication with one or more separate processing plant system(s), physical component(s) of a processing plant, and/or the like. For purposes of simplifying the description, the process 700 is described as performed by and from the perspective of the apparatus 200. In some embodiments, the apparatus 200 performs the operations of the process 1100 utilizing particular means, such as the plant virtualization circuitry 210, optimization circuitry 212, product analysis circuitry 214, routing and control circuitry 216, processor 202, memory 204, input/output circuitry 206, and/or communications circuitry 208, or a combination thereof.

The process 1100 begins at operation 1102. In some embodiments, the process 1100 begins after one or more operations depicted and/or described with respect to any of the other processes described herein. For example, in some embodiments as depicted, the process 1100 begins after execution of the operation 904. In this regard, some or all of the process 1100 may replace or supplement one or more blocks depicted and/or described with respect to any of the other processes described herein. Additionally or alternatively, as depicted, in some embodiments upon completion of the process 1100 the flow returns to one or more operations of another process. For example, in some embodiments, the flow may return to operation 710 as depicted and described.

According to some examples, the method includes determining that the subsequent specification satisfaction indicator comprises a second value representing that the subsequent quality data corresponding to the subsequent stage product does not satisfy the specification requirements data at operation 1102. In some embodiments, the apparatus 200 compares the subsequent specification satisfaction indicator with at least one predetermined value representing satisfaction of the specification requirements data. In a circumstance where the specification satisfaction indicator matches the predetermined value, the apparatus 200 may determine that the subsequent specification satisfaction indicator represents that the specification requirements data was satisfied. It will be appreciated that the subsequent specification satisfaction indicator may be generated based at least in part on subsequent quality data as described herein, for example as described with respect to operation 708, 802, 902, and/or the like.

According to some examples, the method includes causing repeated production via the subsequent stage component or an additional subsequent stage component at operation 1104. In some embodiments, the apparatus 200 causes repeated production by causing the same subsequent stage component to initiate another iteration of a step in a multistage blending process, for example that utilizes a minimal trim optimization process to modify the previously—produced product (e.g., a subsequent stage product produced as part of the current iteration of the multistage blending process). In this regard, the apparatus 200 may continuously utilize the same subsequent stage component to perform such additional iterations until the apparatus 200 determines that the produced subsequent stage product of one of the additional iterations satisfies the specification requirements data. Alternatively or additionally, in some embodiments, the apparatus 200 causes production via an additional subsequent stage component by routing the subsequent stage product to the additional subsequent stage component. In this regard, the additional subsequent stage component may be utilized to cause production of another subsequent stage product via an additional iteration, for example utilizing the same minimal trim optimization process and/or a different minimal trim optimization process. In some embodiments, causing repeated production is performed via the process 1000 as depicted and described herein.

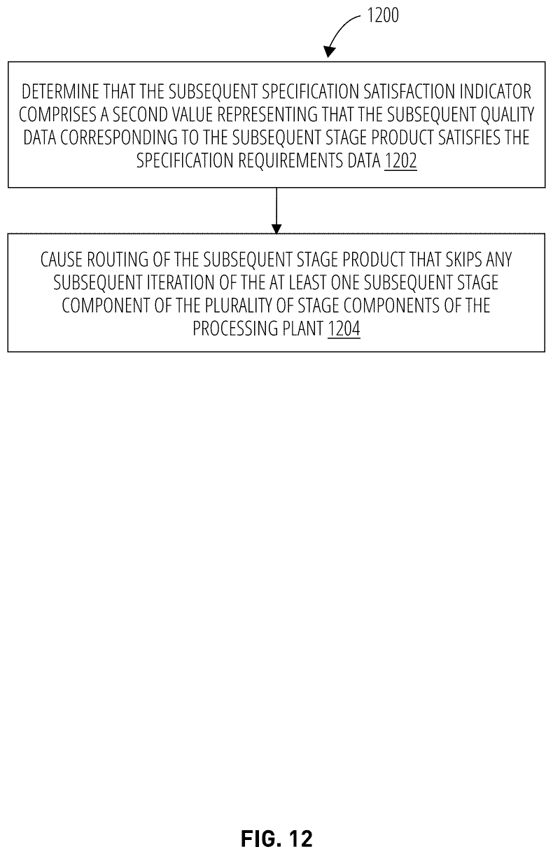

FIG. 12 illustrates a process 1200 for routing a subsequent stage product to skip a subsequent stage, for example as part of an example process for optimizing production in a multi-stage blending configured processing plant, in accordance with an example embodiment of the present disclosure. Specifically, FIG. 12 illustrates an example computer-implemented process 1200. In some embodiments, the process 1200 is embodied by computer program code stored on a non-transitory computer-readable storage medium of a computer program product configured for execution to perform the process as depicted and described. Alternatively or additionally, in some embodiments, the process 1200 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like to perform one or more of the operations as depicted and described. For example, the apparatus 200 in some embodiments is in communication with one or more separate processing plant system(s), physical component(s) of a processing plant, and/or the like. For purposes of simplifying the description, the process 700 is described as performed by and from the perspective of the apparatus 200. In some embodiments, the apparatus 200 performs the operations of the process 1200 utilizing particular means, such as the plant virtualization circuitry 210, optimization circuitry 212, product analysis circuitry 214, routing and control circuitry 216, processor 202, memory 204, input/output circuitry 206, and/or communications circuitry 208, or a combination thereof.

The process 1200 begins at operation 1202. In some embodiments, the process 1200 begins after one or more operations depicted and/or described with respect to any of the other processes described herein. For example, in some embodiments as depicted, the process 1200 begins after execution of the operation 904. In this regard, some or all of the process 700 may replace or supplement one or more blocks depicted and/or described with respect to any of the other processes described herein. Additionally or alternatively, as depicted, in some embodiments upon completion of the process 1200 the flow returns to one or more operations of another process.

According to some examples, the method includes determining that the subsequent specification satisfaction indicator comprises a second value representing that the subsequent quality data corresponding to the subsequent stage product satisfies the specification requirements data at operation 1202. For example, in some embodiments, the apparatus 200 identifies the subsequent quality data associated with the subsequent stage product, and compares that subsequent quality data to specification requirements data for a particular final product. The apparatus 200 may receive from and/or otherwise identify the subsequent quality data utilizing one or more sensor(s) associated with the subsequent stage component that blended or otherwise modified the product, for example as described herein. In this regard, the apparatus 200 may determine that the subsequent specification indicator comprises a second value representing that the subsequent quality data corresponding to the subsequent stage product satisfies the specification requirements data via comparison with one or more predetermined values indicating satisfaction of the specification requirements data (or alternatively, comparison with one or more predetermined values indicating no satisfaction of the specification requirements data). In some embodiments, it will be appreciated that the determination is performed in a manner similarly to that depicted and described with respect to operation 802, for example, based at least in part on data associated with the subsequent stage component.

According to some examples, the method includes causing routing of the subsequent stage product that skips any subsequent iteration of the at least one subsequent stage component of the plurality of stage components of the processing plant at operation 1204. In some embodiments, for example, the apparatus 200 causes routing of the subsequent stage product to a particular physical component of the processing plant for outputting from the processing plant. Such a component in some embodiments includes a tank or related component that stores a final product for lifting by a customer. The physical component may be the same output component that is routed to by other physical components, such as a first stage component and/or other subsequent stage components of the processing plant. In this regard, the subsequent stage product in such contexts embody a final product that skips processing via one or more subsequent iterations performed by the subsequent stage component and/or other subsequent stage components of the processing plant. It will be appreciated that in some embodiments the apparatus 200 causes routing of the subsequent stage product in a similar manner as described with respect to the operation 804, for example, performed via the subsequent stage component.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying FIGURES do not necessarily require the particular order shown, or sequential order, to achieve desirable results. In certain implementations, multitasking and parallel processing may be advantageous.

What is claimed is:

1. A computer-implemented method for plantwide optimization with multistage pre-blending comprising:
generating a virtual representation of a processing plant, wherein the virtual representation includes an aggregation of a plurality of stage components of the processing plant into a single virtual stage component;
generating at least one optimized operational parameter utilizing at least one single-stage optimization process based at least in part on the virtual representation of the processing plant;
causing production, via at least a first stage component of the plurality of components of the processing plant, of a preblended product with minimized deviation from the at least one optimized operational parameter;
generating specification satisfaction indicator by determining whether quality data corresponding to the preblended product satisfies specification requirements data; and
causing routing of the preblended product based at least in part on the specification satisfaction indicator.

2. The computer-implemented method of claim 1, wherein causing routing the preblended product based at least in part on the specification satisfaction indicator comprises:
determining that the specification satisfaction indicator comprises a first value representing that the quality data corresponding to the preblended product does not satisfy the specification requirements data; and
causing routing of the preblended product to a subsequent stage component of the plurality of stage components of the processing plant.

3. The computer-implemented method of claim 2, the computer-implemented method further comprising:
at least once:
causing production, via the subsequent stage component of the plurality of components of the processing plant, of a subsequent stage product with based at least in part on a minimal trim optimization process;
generating subsequent specification satisfaction indicator by determining whether subsequent quality data corresponding to the subsequent stage product satisfies the specification requirements data; and
causing routing of the subsequent stage product based at least in part on the subsequent specification satisfaction indicator.

4. The computer-implemented method of claim 3, wherein causing routing of the preblended product based at least in part on the subsequent specification satisfaction indicator comprises:
determining that the subsequent specification satisfaction indicator comprises a second value representing that the subsequent quality data corresponding to the subsequent stage product does not satisfy the specification requirements data; and
causing repeated production via the subsequent stage component.

5. The computer-implemented method of claim 3, wherein causing routing of the preblended product based at least in part on the subsequent specification satisfaction indicator comprises:
determining that the subsequent specification satisfaction indicator comprises a second value representing that the second quality data corresponding to the subsequent stage product satisfies the specification requirements data; and
causing routing of the subsequent stage product that skips any subsequent iteration of the at least one subsequent stage component of the plurality of stage components of the processing plant.

6. The computer-implemented method of claim 1, wherein causing routing the preblended product based at least in part on the specification satisfaction indicator comprises:
determining that the specification satisfaction indicator comprises a second value represent that the quality data corresponding to the preblended product satisfies the specification requirements data; and
causing routing of the preblended product that skips at least one subsequent stage component of the plurality of stage components of the processing plant.

7. The computer-implemented method of claim 6, wherein causing routing of the preblended product that skips at least one subsequent stage component comprises causing outputting of the preblended product.

8. The computer-implemented method of claim 1, wherein the at least one optimized operational parameter comprises a target ingredient amount inputted to the first stage component during production of the preblended product.

9. An apparatus comprising:
at least one processor; and
at least one memory storing computer-coded instructions that, when executed by the processor, causes the apparatus to:
generate a virtual representation of a processing plant, wherein the virtual representation includes an aggregation of a plurality of stage components of the processing plant into a single virtual stage component;
generate at least one optimized operational parameter utilizing at least one single-stage optimization process based at least in part on the virtual representation of the processing plant;
cause production, via at least a first stage component of the plurality of components of the processing plant, of a preblended product with minimized deviation from the at least one optimized operational parameter;
generate specification satisfaction indicator by determining whether quality data corresponding to the preblended product satisfies specification requirements data; and
cause routing of the preblended product based at least in part on the specification satisfaction indicator.

10. The apparatus of claim 9, wherein to route the preblended product based at least in part on the specification satisfaction indicator, the apparatus is caused to:
determine that the specification satisfaction indicator comprises a first value representing that the quality data corresponding to the preblended product does not satisfy the specification requirements data; and
cause routing of the preblended product to a subsequent stage component of the plurality of stage components of the processing plant.

11. The apparatus of claim 10, wherein the instructions further cause the apparatus to:
at least once:
cause production, via the subsequent stage component of the plurality of components of the processing plant, of a subsequent stage product with based at least in part on a minimal trim optimization process;
generate subsequent specification satisfaction indicator by determining whether subsequent quality data corresponding to the subsequent stage product satisfies the specification requirements data; and
cause routing of the subsequent stage product based at least in part on the subsequent specification satisfaction indicator.

12. The apparatus of claim 11, wherein to route the preblended product based at least in part on the subsequent specification satisfaction indicator, the apparatus is caused to:
determine that the subsequent specification satisfaction indicator comprises a second value representing that the subsequent quality data corresponding to the subsequent stage product does not satisfy the specification requirements data; and
cause repeated production via the subsequent stage component.

13. The apparatus of claim 11, wherein to route of the preblended product based at least in part on the subsequent specification satisfaction indicator, the apparatus is caused to:
determine that the subsequent specification satisfaction indicator comprises a second value representing that the second quality data corresponding to the subsequent stage product satisfies the specification requirements data; and
cause routing of the subsequent stage product that skips any subsequent iteration of the at least one subsequent stage component of the plurality of stage components of the processing plant.

14. The apparatus of claim 9, wherein to route the preblended product based at least in part on the specification satisfaction indicator, the apparatus is caused to:
determine that the specification satisfaction indicator comprises a second value represent that the quality data corresponding to the preblended product satisfies the specification requirements data; and
cause routing of the preblended product that skips at least one subsequent stage component of the plurality of stage components of the processing plant.

15. The apparatus of claim 14, wherein the apparatus routes the preblended product to skip at least one subsequent stage component comprises causing outputting of the preblended product.

16. The apparatus of claim 9, wherein the at least one optimized operational parameter comprises a target ingredient amount inputted to the first stage component during production of the preblended product.

17. A non-transitory computer-readable storage medium, the computer-readable storage medium comprising computer program code that when executed by at least one processor, configures the at least one processor to:
generate a virtual representation of a processing plant, wherein the virtual representation includes an aggregation of a plurality of stage components of the processing plant into a single virtual stage component;
generate at least one optimized operational parameter utilizing at least one single-stage optimization process based at least in part on the virtual representation of the processing plant;
cause production, via at least a first stage component of the plurality of components of the processing plant, of a preblended product with minimized deviation from the at least one optimized operational parameter;
generate specification satisfaction indicator by determining whether quality data corresponding to the preblended product satisfies specification requirements data; and
cause routing of the preblended product based at least in part on the specification satisfaction indicator.

18. The computer-readable storage medium of claim 17, wherein causing routing the preblended product based at least in part on the specification satisfaction indicator comprises:
determine that the specification satisfaction indicator comprises a first value representing that the quality data corresponding to the preblended product does not satisfy the specification requirements data; and
cause routing of the preblended product to a subsequent stage component of the plurality of stage components of the processing plant.

19. The computer-readable storage medium of claim 18, the computer-implemented method wherein the instructions further configure the computer to:
at least once:
cause production, via the subsequent stage component of the plurality of components of the processing plant, of a subsequent stage product with based at least in part on a minimal trim optimization process;
generate subsequent specification satisfaction indicator by determining whether subsequent quality data corresponding to the subsequent stage product satisfies the specification requirements data; and
cause routing of the subsequent stage product based at least in part on the subsequent specification satisfaction indicator.

20. The computer-readable storage medium of claim 17, wherein causing routing the preblended product based at least in part on the specification satisfaction indicator comprises:
determine that the specification satisfaction indicator comprises a second value represent that the quality data corresponding to the preblended product satisfies the specification requirements data; and
cause routing of the preblended product that skips at least one subsequent stage component of the plurality of stage components of the processing plant.
